(19) United States
(12) Patent Application Publication
(10) Pub. No.: US 2008/0144980 A1
(43) Pub. Date: Jun. 19, 2008

(54) Linear Roller Bearing with a U-Shaped Scraper Arranged on the Front Face of the Guide Carriage

(75) Inventors: Peter Keller, Bruchmuehlbach-Miesau (DE); Dietmar Rudy, Kleinbundenbach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/814,852

(22) PCT Filed: Dec. 17, 2005
(86) PCT No.: PCT/EP05/13633

§ 371 Date: Aug. 15, 2007

(30) Foreign Application Priority Data
Jan. 27, 2005 (DE) 10 2005 003 711.9

(51) Int. Cl. B23Q 11/08; F16C 29/08; F16C 29/06

(52) U.S. Cl. 384/15

(57) ABSTRACT

Linear rolling bearing, having a guide carriage (2) which is mounted by means of rolling bearings on a guide rail (1), and having at least one approximately u-shaped scraper (3), arranged at the end side on the guide carriage (2), for scraping foreign objects such as chips, dust and cooling liquids from the guide rail, with the scraper (3) being in scraping contact, by means of its scraping system (16), preferably sealing lip (16a) or sealing edge, with the guide rail (1), wherein the scraper (3) has a preferably plate-shaped seal (16a) which is provided with the scraping system (16) and at whose points, for example corners, which are of increased stiffness on account of the shape of the seal, are provided targeted material weakenings which increase the flexibility of the scraping system at said points.

The present invention relates to a linear rolling bearing, having a guide carriage which is mounted by means of rolling bearings on a guide rail.

Guide carriages of said type are often provided at their end sides with scrapers which scrape away foreign objects such as chips, dust and cooling liquids from the guide rail and therefore prevent the infiltration of said foreign objects into the guide carriage and in particular into the region of raceways for the rolling bodies. A linear rolling bearing of said type is for example known from U.S. Pat. No. 5,590,965 A. The guide rail is provided at its two longitudinal sides in each case with two ball grooves into which the scraper engages with its scraping system. On account of the contour of the guide rail, the scraping system—preferably sealing lip or sealing edge—undergoes pronounced deflections along its direction of extent around the periphery of the guide rail. Said partially pronounced deflections between adjacent ball grooves generate points of increased stiffness. If said scraping system is resiliently compressed uniformly along its extent by a certain degree, when said scraping system is in scraping contact with the guide rail, an increased pressing force of the scraping system against the guide rail is generated at points on account of the region of increased stiffness. However, said increased pressing force for example of the sealing edge leads to an increased degree of wear of the scraper, so that correct functioning of the scraper is not ensured.

It is an object of the present invention to specify a linear rolling bearing according to the features of the preamble of claim 1, in which uniform wear of the scraping system of the scraper is ensured.

According to the invention, said object is achieved in that the scraper has a preferably plate-shaped seal which is provided with the scraping system and at whose points, for example corners, which are of increased stiffness on account of the contour of the scraping system, are provided targeted material weakenings which increase the flexibility of the scraping system at said points. The guide carriage is preferably of unshaped design and engages with its two limbs around the guide rail. The scraper is then in scraping contact, by means of its scraping system, with the two longitudinal sides and with the upper side of the guide rail. If the scraper is in scraping contact with the longitudinal sides and with the upper side of the guide rail, the sealing edge or the sealing lip of the scraper is elastically compressed uniformly along its extent. Here, the points of increased flexibility have the effect that the contact pressure of the scraping system is at least approximately uniform along its extent in the peripheral direction around the guide rail.

Said material weakening can be formed as a cutout or recess on the plate-shaped seal close to the scraping system.

Said seals can expediently be formed in an injection molding process. It is easily possible in the injection mold to incorporate cutouts or recesses which later contribute on the seal to a targeted material weakening.

The preferably unshaped and plate-shaped seal is in scraping contact, by means of its two limbs, with the longitudinal sides of the guide rail, and by means of its transverse web which connects the two limbs, with the upper side of the guide rail. In the region of the corners formed by the two limbs and the transverse web, the seal can be provided with recesses such that increased flexibility is ensured in said corners.

Depending on the design of the linear rolling bearing, it is possible for lugs to be provided on said limbs, which lugs project in the direction of the in each case opposite limb and the inner periphery of which lugs is provided with the scraping system. Said recesses are then likewise provided on said lugs, which can be applied in particular when said lug causes pronounced deflections of the scraping system.

The invention is explained in more detail below on the basis of an exemplary embodiment which is depicted in a total of four figures, in which:

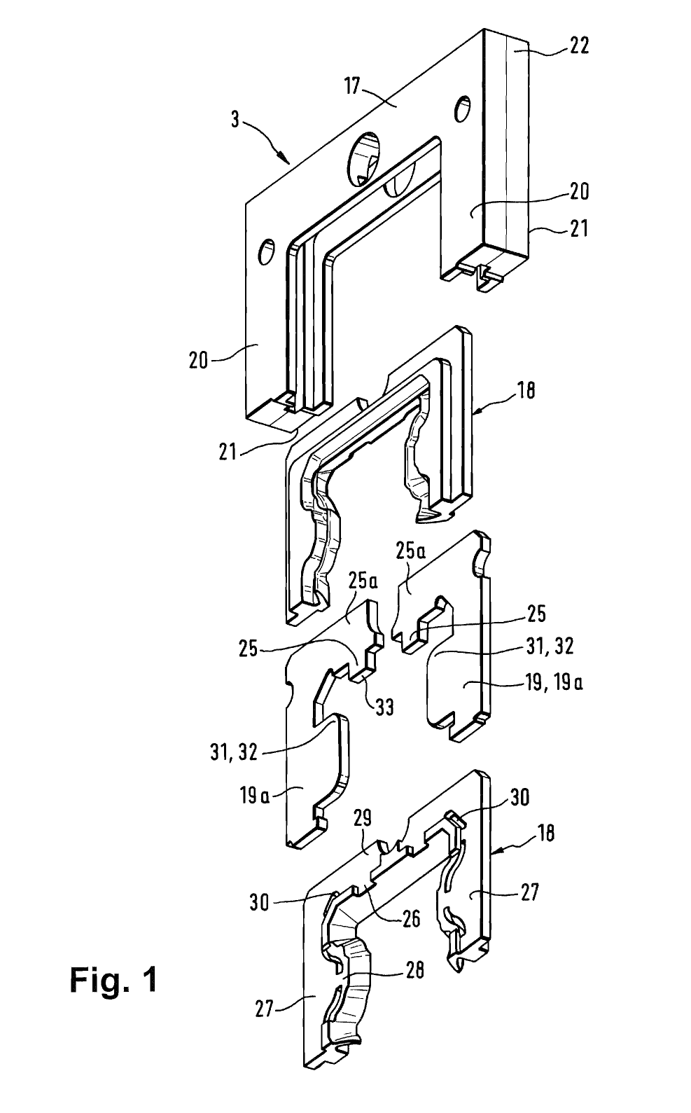

FIG. 1 shows a scraper according to the invention in an exploded illustration,

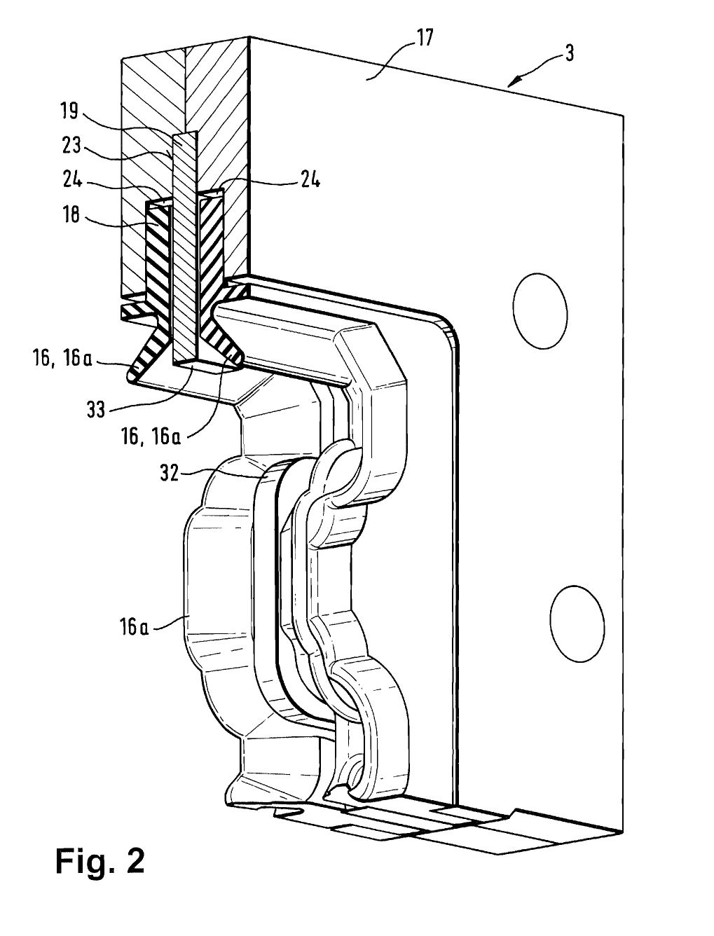

FIG. 2 shows the scraper from FIG. 1 in a perspective illustration and in section,

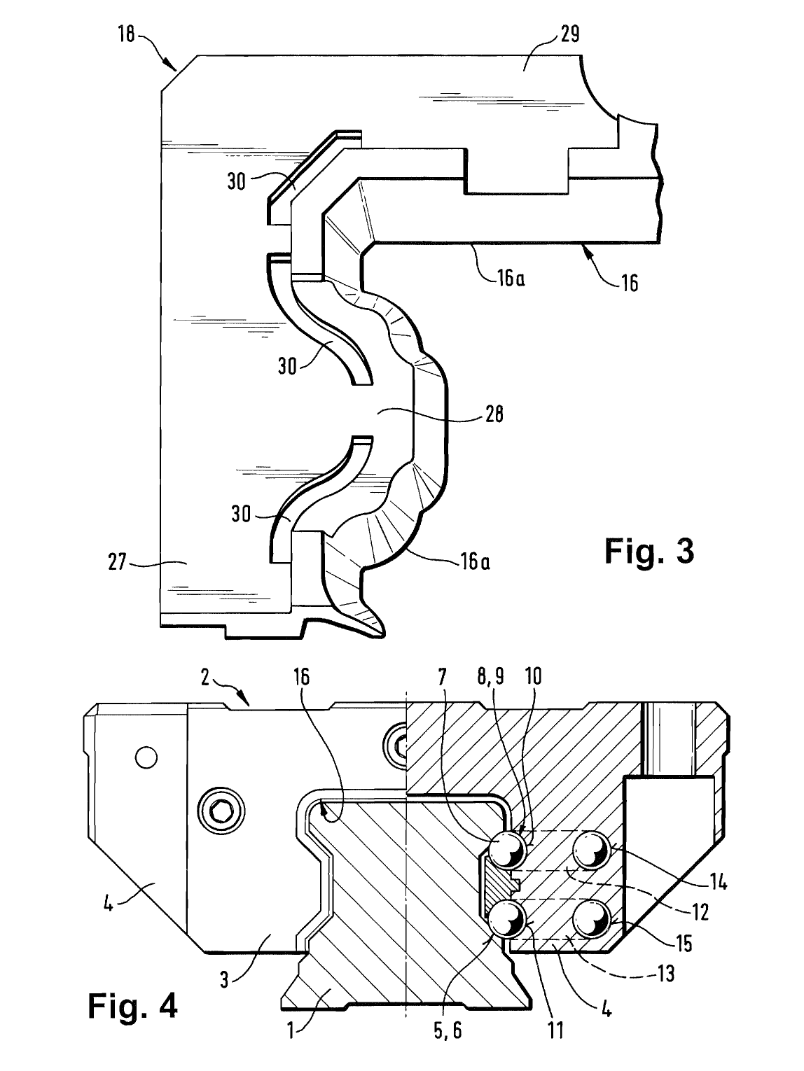

FIG. 3 shows a seal of the scraper as per FIG. 2 in a perspective and enlarged illustration, and

FIG. 4 shows a linear rolling bearing according to the invention, partially in section.

### DETAILED DESCRIPTION OF THE DRAWING

The linear rolling bearing according to the invention depicted in FIG. 4 has a guide carriage 2 which is guided in a longitudinally moveable manner on a guide rail 1. Scrapers 3 are detachably fastened to both end sides of the guide carriage 2. The guide carriage 2 has a substantially unshaped profile. The guide carriage 2 engages with its two limbs 4 around the guide rail 1.

The guide rail 1 has an upper side and, situated opposite one another, two longitudinal sides, with the longitudinal sides being provided in each case with a plurality of raceways 6, which are formed by ball grooves 5, for balls 7. The four ball grooves 5 of the guide rail 1 are arranged in an O-arrangement with one another.

The guide carriage 2 has, on its two limbs 4 on its sides which face toward the longitudinal sides of the guide rail 1, in each case two raceways 8 which face the raceways 6 and are likewise formed as ball grooves 9. The ball grooves 5, 9 of the guide rail 1 and of the guide carriage 2 delimit first and second load channels 10, 11 in which the balls 7 roll under load on the ball grooves 5, 9. Deflecting channels 12, 13 and return channels 14, 15, which are indicated by dashed lines, connect the start and end of the load channels 10, 11 to one another in a continuous manner.

If tensile forces engage on the guide carriage 2, which pull the guide carriage 2 upward away from the guide rail 1, the balls 7 of the first load channels 10 transmit the load. The load channel 10 accordingly has a tension raceway. If compressive forces act on the guide carriage 2, the second load channels transmit the load. The load channel 11 accordingly has a compression raceway.

The scraper 3 is provided at its inner periphery with a scraping system 16 which is formed in the present case by a sealing lip 16a, as can be seen in particular from FIG. 2 which is described further below. The scraping system 16 is matched to the contour of the guide rail 1. The scraper 3 is in scraping contact, by means of its scraping system 16, with the upper side and with the two longitudinal sides of the guide rail 1.

The scraper 3 will now be described in detail below on the basis of FIGS. 1 to 3. FIG. 1 shows the individual parts of the scraper 3 according to the invention. In a housing 17, two plate-shaped seals 18, which are formed from flexible material, are arranged in series in the rail direction. Arranged between the two seals 18 is a support plate 19 against which the two seals 18 are supported by means of their sides which face toward the support plate 19.

The housing 17, as viewed in longitudinal section through the guide carriage 2, has an approximately u-shaped section profile which is open toward the guide rail 1. The two limb parts 20, 21 of said section profile form a front wall and a rear wall of the housing 17, with the rear wall facing toward the guide carriage 2. A base part 22, which connects the two limb parts 20, 21, forms a peripheral wall of the housing 17.

The housing 17 is provided with a first receptacle 23 for the support plate 19. When the support plate 19 is arranged correctly in the first receptacle 23, the support plate 19 is aligned positionally accurately in all spatial axes. FIG. 2 shows the first receptacle 23 with a rectangular cross section, with said first receptacle 23 being formed both in the base part 23 and also in the limb parts 20, 21.

The housing 17 is also provided with a second receptacle 24 for the two seals 18. The two second receptacles 24 are likewise depicted in FIG. 2. The second receptacles 24 are also formed here as rectangular recesses both in the base part 22 and in the limb parts 20, 21. When the seals 18 are held correctly in said second receptacles 24, said seals 18 are aligned positionally accurately in all spatial axes. The seals 18 are supported with their one end side on the front wall and on the rear wall of the housing 17, and with their other end side on the support plate 19. Even if one of the two seals 18 is removed, it is therefore ensured that the other, remaining seal 18 is held correctly and positionally accurately in the housing 17.

The plate-shaped seals 18 can be easily removed from the housing 17 and replaced with other seals. If the guide carriage 2 with the mounted scraper 3 is arranged on the guide rail 1, it is necessary merely for the scraper 3 to be detached from the guide carriage 2. The housing 17 of the scraper 3 can then be removed from the guide rail 1 upward. The two seals 18 and the support plate 19 can initially remain on the guide rail 1. Since the two seals 18 are preferably formed from a flexible material, said seals can be bent such that they can be removed from the guide rail 1. New seals can then be placed on, and the housing can be placed back on again.

The seals 18 and the support plate 19 are additionally connected to one another in a form-fitting manner. As can be seen from FIG. 1, the support plate 19 is provided with two projections 25. The two projections 25 are formed in each case on a transverse web 25a of the limb 19a of the support plate 19. The two seals 18 are provided with in each case two recesses 26, with the projections 25 of the support plate 19 engaging into the recesses 26 of the two seal. The depth of the recesses 26 is approximately half of the thickness of the support plate 19. Since the two seals 18 are arranged to both sides of the support plate 19, it is accordingly possible for the two projections 25 of the support plate 19 to engage both into the recesses 26 of the one and of the other seal 18. The support plate 19, which in the present case is of two-part design, can also be of single-part design. The two transverse webs 25a of the support plate 19 are then connected to one another in one piece.

In the four-row linear rolling bearing with an O-arrangement illustrated here, the ball grooves 5, 9 on the guide rail 1 are arranged in such a way that the two limbs 27 of the seal 18, which is of u-shaped design, are provided at their sides which face toward one another in each case with a projecting lug 27. FIG. 3 shows a part of the seal 18 in a perspective illustration with the lug 28. It can also be clearly seen from said figure that the sealing lip 16a is matched to the contour of the guide rail 1, so that the sealing lip 16a is correctly in scraping contact with the guide rail 1.

Between the lug 28 and the transverse web 29, which connects the two limbs 27, of the seal 18, the sealing lip 16a undergoes pronounced deflections along its contour. In this way, shape-related points of increased stiffness are formed along the extent of the sealing lip 16a. Since it is however advantageous if the contact pressure of the sealing lip 16a against the guide rail 1 is uniform, targeted material weakenings are provided on the seal 18 at said points of increased stiffness. Said targeted material weakenings are formed in the exemplary embodiment in that, at the points of increased stiffness, a plurality of recesses are provided, which recesses extend through the seal 18 and form slots 30. Said slots 30 are arranged at a small distance from the sealing lips 16a. The sealing lips 16a are accordingly not supported at said points, and can be compressed resiliently in the direction of the slots 30. It is possible in this way to ensure uniform pressure of the sealing lip 16a along the entire extent in a targeted manner.

Said slots 30 are provided both in the region of the lugs 28 and in the region of corners which are formed by the two limbs 27 and the transverse web 29.

If seals 18 for linear rolling bearings of said type are to be mounted on the guide carriage 2, it is to be ensured that the seals 18 are aligned correctly with respect to the guide rail 2. Correct scraping contact of the scraper 3 against the guide rail 1 is otherwise not ensured. Positionally accurate alignment of the seal 18—be it here with scrapers with or without a housing—is complicated by the acting elastic restoring forces of the sealing lip 16a which bears against the guide rail 1, as is explained below. If one imagines that the sealing lip 16a in the region of the transverse web 29 is removed, then there is no contact of the seal against the guide rail 1 on the upper side of the guide rail 1. Only the two limbs 27 with their sealing lip 16a are then in scraping contact against the guide rail 1. In this case, the sealing lips 16a are compressed resiliently against the longitudinal sides of the guide rail 1. The acting pressure forces of the sealing lips 16a at both sides of the guide rail 1 are in force equilibrium, so that in this situation, correct alignment of the seal 18 in relation to the guide rail 1 is given.

In reality, however, additional elastic restoring forces of the sealing lip 16a act in the region of the transverse web 29, so that the seal 18 is resiliently forced or pulled upward away from the guide rail 1. This means that the sealing lips 16a, in the region of the lugs 28, are pressed to an increased degree against the ball groove 5, which forms the tension raceway, of the first rolling body channel 10 of the guide rail 1.

If the scraper 3 is fixed to the guide carriage 2 in this impermissible alignment, then the sealing lip 16a is subjected to increased wear, so that a reliable scraping action is not ensured. In order to ensure that no impermissible deformation of the sealing lip can occur when mounting the scraper onto the guide carriage, the scraper 3 is provided with a stop 31, as is shown in FIG. 1 with regard to the support plate 19. Said stop 31 is provided for abutment against the ball groove 5, of the guide rail 1, of the first rolling body channel. It can be seen from FIG. 1 that the stop 31 is formed on a lug 32. The support plate 19 has the integrally formed lugs 32 in each case on its two limbs. It can be seen from FIG. 2 that the sealing lip 16a projects slightly beyond the lug 32. If the seal 18 is positioned correctly with respect to the guide rail 1, it is therefore ensured that the lug 32 is out of contact with the guide rail 1. If, on account of the acting restoring forces of the sealing lip 16a against the upper side of the guide rail 1, the scraper 3 which has not yet been fixed to the guide carriage 2 is pulled upward, then this can occur only until the lug 32 abuts against the guide rail 1. In this abutment situation, it is ensured that the sealing lip 16a is not impermissibly deformed. A technician carrying out the assembly can additionally easily determine, on account of the abruptly increased resistance, that the stop 31 is already bearing against the guide rail 1.

The scraper 3 is provided with a further stop 33. Said stop 33 is formed on the projection 25, as already described further above, of the support plate 19. The sealing lip 16a projects beyond said stop 33 in the direction of the upper side of the guide rail 1. If, while being mounted onto the guide carriage 2, the scraper 3 is pressed too far downward, then the stop 33 abuts against the upper side of the guide rail 1. On account of the stop 33, the sealing lip 16a which bears against the upper side is not pressed impermissibly intensely against the upper side, and is therefore not damaged. Between the two described abutment situations, the scraper 3 is positioned correctly, preferably in a central position, and can be fixed to the guide carriage 2.

### LIST OF REFERENCE SYMBOLS

1 Guide rail
2 Guide carriage
3 Scraper
4 Limb
5 Ball groove
6 Raceway
7 Ball
8 Raceway
9 Ball groove
10 First load channel
11 Second load channel
12 Deflecting channel
13 Deflecting channel
14 Return channel
15 Return channel
16 Scraping system
16a Sealing lip
17 Housing
18 Seal
19 Support plate
19a Limb
20 Limb part
21 Limb part
22 Base part
23 First receptacle
24 Second receptacle
25 Projection
25a Transverse web
26 Recess
27 Limb
28 Lug
29 Transverse web
30 Slot
31 Stop
32 Lug
33 Stop

1. Linear rolling bearing, comprising: a guide carriage which is mounted by means of rolling bearings on a guide rail, and having at least one approximately u-shaped scraper, arranged at the end side on the guide carriage, for scraping foreign objects such as chips, dust and cooling liquids from the guide rail, with the scraper being in scraping contact with the guide rail, wherein the scraper has a plate-shaped seal which is provided with the scraping system and at whose points are of increased stiffness on account of the shape of the seal, are provided targeted material weakenings which increase the flexibility of the scraping system at said points.

2. Linear rolling bearing according to claim 1, wherein the material weakening is formed as a cutout or recess on the plate-shaped seal close to the scraping system.

3. Linear rolling bearing according to claim 1, wherein the u-shaped and plate-shaped seal is in scraping contact, by means of its two limbs, with the longitudinal sides of the guide rail, and by means of its transverse web which connects the two limbs, with the upper side of the guide rail.

4. Linear rolling bearing according to claim 3, wherein the seal is provided with the recesses in the region of the corners formed by the two limbs and the transverse web.

5. Linear rolling bearing according to claim 3, wherein the seal is provided on its two limbs with lugs which project in the direction of the in each case opposite limb, with the recesses being formed on the lugs.
